(19) United States
(12) Patent Application Publication
(10) Pub. No.: US 2016/0361711 A1
(43) Pub. Date: Dec. 15, 2016

(54) Zero-PGM TWC with High Redox Reversibility

(71) Applicant: Clean Diesel Technologies, Inc., Oxnard, CA (US)

(72) Inventors: Zahra Nazarpoor, Camarillo, CA (US); Stephen J. Golden, Santa Barbra, CA (US)

(21) Appl. No.: 15/182,330

(22) Filed: Jun. 14, 2016

Related U.S. Application Data
(60) Provisional application No. 62/175,956, filed on Jun. 15, 2015.

(51) Int. Cl. B01J 23/889; B01D 53/94; B01J 35/02; C01G 45/12; B01J 23/00

(52) U.S. Cl. CPC B01J 23/8892; C01G 45/1235; B01J 23/005; B01J 35/026; B01D 53/945; B01D 2255/405

(57) ABSTRACT

The present disclosure describes zero-platinum group metals (ZPGM) material compositions including binary Cu—Mn spinel oxide powders having stable reduction/oxidation (redox) reversibility useful for TWC and oxygen storage material applications. The behavior of Cu—Mn spinel oxide powder is analyzed under oxidation-reduction environments to determine redox reversibility, catalytic activity, and spinel structure stability. Characterization of spinel powder is performed employing X-ray diffraction analysis, hydrogen temperature-programmed reduction technique, transmission electron microscopy analysis, and X-ray photoelectron spectroscopy analysis. Test results confirm the phase and structural stability of the Cu—Mn spinel oxide during redox reaction, thereby indicating that the Cu—Mn spinel oxide can be employed in a plurality of TWC applications.

### CROSS-REFERENCE TO RELATED APPLICATIONS

This application claims priority to U.S. Provisional Application Ser. No. 62/175,956, filed Jun. 15, 2015, which is hereby incorporated by reference.

### BACKGROUND

Field of the Disclosure

This disclosure relates generally to zero-PGM (ZPGM) catalyst materials, and more particularly, to reversible redox properties of spinel oxide materials for use in a plurality of catalyst applications.

Background Information

Conventional gasoline exhaust systems employ three-way catalysts (TWC) technology and are referred to as TWC systems. TWC systems convert the toxic CO, HC and NOx into less harmful pollutants. Typically, TWC systems include a substrate structure upon which a layer of supporting and sometimes promoting oxides are deposited. Catalysts, based on platinum group metals (PGM), are then deposited upon the supporting oxides. Conventional PGM materials include platinum (Pt), palladium (Pd), rhodium (Rh), iridium (Ir), or combinations thereof.

Although PGM catalyst materials are effective for toxic emission control and have been commercialized by the emissions control industry, PGM materials are scarce and expensive. This high cost remains a critical factor for widespread applications of PGM catalyst materials. As changes in the formulation of catalysts continue to increase the cost of TWC systems, the need for catalysts of significant catalytic performance has directed efforts toward the development of catalytic materials capable of providing the required synergies to achieve greater catalytic performance. Additionally, compliance with ever stricter environmental regulations and the need for lower manufacturing costs require new types of TWC systems. Therefore, there is a continuing need to provide TWC systems exhibiting catalytic properties substantially similar to or exceeding the catalytic properties exhibited by conventional TWC systems employing high PGM catalyst materials.

### SUMMARY

The present disclosure describes zero-platinum group metals (ZPGM) material compositions including binary spinel oxide powders to develop suitable ZPGM catalyst materials. Further, the present disclosure describes reduction/oxidation (redox) reversibility, catalytic performance, and thermal stability of the aforementioned ZPGM catalyst materials. These ZPGM catalyst materials can be employed for a variety of catalyst applications, such as, for example oxygen storage material (OSM) applications, and ZPGM and ultra-low loading synergized-PGM (SPGM) three-way catalyst (TWC) systems, amongst others.

In some embodiments, the ZPGM catalyst materials include binary spinel oxide compositions, which are synthesized using conventional synthesis methodologies to produce spinel oxide powders. In these embodiments, the binary spinel oxide composition is implemented as copper (Cu)-manganese (Mn) spinel oxide compositions. Further to these embodiments, the Cu—Mn spinel oxide is produced using a general formulation Cu_{X}Mn_{3-X}O₄ in which X is a variable representing molar ratios within a range from about 0.01 to about 2.99. In an example, X takes a value of about 1.0 for a stoichiometric CuMn₂O₄ spinel oxide powder.

In some embodiments, the redox behavior of the Cu—Mn spinel oxide powder is analyzed within oxidation-reduction environments. In these embodiments, functional testing and chemical characterization of Cu—Mn spinel powder are conducted to assess the formation of the spinel phase, the reversible redox property, thermal stability, and the catalytic activity of the Cu—Mn spinel powder. Further to these embodiments, the chemical characterization of the Cu—Mn spinel powder is performed during a redox cycling process employing X-ray diffraction (XRD) analysis, hydrogen temperature-programmed reduction (H₂-TPR) technique, transmission electron microscopy (TEM) analysis, and X-ray photoelectron spectroscopy (XPS) analysis.

The chemical characterization of the spinel powder confirms the significant redox property and reversibility of the Cu—Mn spinel oxide under reduction/oxidation environments. In other words, the Cu—Mn spinel structure, which is free of PGM and rare-earth metals, exhibits significant redox stability and reversibility that can enable catalyst materials in bulk powder format for the development of a plurality of TWC systems and other catalyst applications.

Numerous other aspects, features, and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 is a graphical representation illustrating a powder X-ray diffraction (XRD) phase analysis of a copper (Cu)-manganese (Mn) spinel oxide, according to an embodiment.

FIG. 2 is a graphical representation illustrating high-resolution transmission electron microscopy (HRTEM) and energy-dispersive X-ray spectroscopy (EDS) analyses of a fresh Cu—Mn spinel powder, according to an embodiment.

FIG. 3 is a graphical representation illustrating a reduction/oxidation (redox) reversibility cycle of a Cu—Mn spinel powder under reduction/oxidation conditions, according to an embodiment.

FIG. 4 is a graphical representation illustrating an XRD phase analysis for the entire redox reversibility cycle of a Cu—Mn spinel powder under reduction/oxidation conditions, according to an embodiment.

FIG. 5 is a graphical representation illustrating an XRD phase analysis of a Cu—Mn spinel powder fresh, after the reduction step, and after oxidation step, according to an embodiment.

FIG. 6 is a graphical representation illustrating results from a hydrogen temperature-programmed reduction (H₂-TPR) test of a Cu—Mn spinel powder, according to an embodiment.

FIG. 7 is a graphical representation illustrating light-off (LO) test results of NO conversion percentages associated with a Cu—Mn spinel powder fresh, after the reduction step, and after the oxidation step, according to an embodiment.

FIG. 8 is a graphical representation illustrating elemental oxidation states within the redox reversibility cycle of a Cu—Mn spinel powder employing X-ray photoelectron spectroscopy (XPS) analysis, according to an embodiment.

FIG. 9 is a graphical representation illustrating an elemental mapping analysis for a Cu—Mn spinel powder after partial reduction in a CO environment, employing scanning transmission electron microscopy (STEM) test and energy-dispersive X-ray spectroscopy (EDX) analysis, according to an embodiment.

FIG. 10 is a graphical representation illustrating a transmission electron microscopy (TEM) analysis of a Cu—Mn spinel powder after partial reduction in a CO environment, according to an embodiment.

### DETAILED DESCRIPTION

The present disclosure is described herein in detail with reference to embodiments illustrated in the drawings, which form a part hereof Other embodiments may be used and/or other modifications may be made without departing from the scope or spirit of the present disclosure. The illustrative embodiments described in the detailed description are not meant to be limiting of the subject matter presented.

Definitions

As used here, the following terms have the following definitions:

“Calcination” refers to a thermal treatment process applied to solid materials, in presence of air, to bring about a thermal decomposition, phase transition, or removal of a volatile fraction at temperatures below the melting point of the solid materials.

“Catalyst” refers to one or more materials that may be of use in the conversion of one or more other materials.

“Conversion” refers to the chemical alteration of at least one material into one or more other materials.

“Energy-dispersive X-ray spectroscopy (EDS, EDX, or XEDS) analysis” refers to an analytical technique used for the elemental or chemical compositional analysis of a material, based on the fundamental principle that each element has a unique atomic structure, thereby allowing a unique set of peaks on its X-ray emission spectrum.

“High-resolution transmission electron microscopy or HRTEM testing” refers to an imaging mode of the transmission electron microscope (TEM) that allows for direct imaging of the atomic structure of the sample to study properties of materials on the atomic scale, such as, for example metals, nanoparticles, graphene, and C nanotubes, amongst others.

“Lattice matching” refers to a matching of a unit cell of an unknown material against a database of known materials represented by their respective standard unit cell dimensions to determine the unknown materials lattice parameters and identify the unknown material.

“Lattice parameter or lattice constant” refers to the physical dimension of unit cells in a crystal lattice. Lattices in three dimensions have three lattice constants, referred to as a, b, and c. However, in the special case of cubic crystal structures, all of the constants are equal and only referred to a.

“Platinum group metals (PGM)” refers to platinum, palladium, ruthenium, iridium, osmium, and rhodium.

“Scanning transmission electron microscope (STEM)” refers to a type of transmission electron microscope (TEM) testing in which the electrons pass through a sufficiently thin specimen by focusing an electron beam into a narrow spot which is scanned over the sample raster.

“Spinel” refers to any minerals of the general formulation AB₂O₄ where the A ion and B ion are each selected from mineral oxides, such as, for example magnesium, iron, zinc, manganese, aluminum, chromium, titanium, cobalt, nickel, or copper, amongst others.

“Support oxide” refers to porous solid oxides, typically mixed metal oxides, which are used to provide a high surface area that aids in oxygen distribution and exposure of catalysts to reactants, such as, for example NO_{X}, CO, and hydrocarbons.

“Temperature-programmed reduction (TPR)” refers to a technique for the characterization of solid materials often used in the field of heterogeneous catalysis to find the most efficient reduction conditions, in which a catalyst precursor is submitted to a programmed temperature rise, while a reducing gas mixture is flowed over it.

“Three-way catalyst (TWC)” refers to a catalyst that performs the three simultaneous tasks of reduction of nitrogen oxides to nitrogen and oxygen, oxidation of carbon monoxide to carbon dioxide, and oxidation of unburnt hydrocarbons to carbon dioxide and water.

“X-ray diffraction (XRD) analysis” refers to an analytical technique for identifying crystalline material structures, including atomic arrangement, crystalline size, and imperfections in order to identify unknown crystalline materials (e.g., minerals, inorganic compounds).

“X-ray photoelectron spectroscopy (XPS) analysis” refers to a surface-sensitive quantitative spectroscopy technique that measures the elemental composition at the parts per thousand range, empirical formula, chemical state, and electronic state of the elements that exist within a material.

### DESCRIPTION OF THE DISCLOSURE

The present disclosure describes zero-platinum group metals (ZPGM) material compositions including binary spinel oxide powders to develop suitable ZPGM catalyst materials. Further, the present disclosure describes reduction/oxidation (redox) reversibility, catalytic performance, and thermal stability of the aforementioned ZPGM catalyst materials using various chemical characterization and catalyst functional testing. These ZPGM catalyst materials can be employed for a variety of catalyst applications, such as, for example oxygen storage material (OSM) applications, and ZPGM and ultra-low loading synergized PGM (SPGM) three-way catalyst (TWC) systems, amongst others.

ZPGM Catalyst Material Composition and Preparation

In some embodiments, the ZPGM catalyst materials include binary spinel oxide compositions, which are synthesized using conventional synthesis methodologies to produce spinel oxide powders.

In these embodiments, the binary spinel oxide composition is implemented as copper (Cu)-manganese (Mn) spinel oxide compositions. Further to these embodiments, the Cu—Mn spinel oxide is produced using a general formulation Cu_{X}Mn_{3-X}O₄ spinel in which X is a variable representing molar ratios within a range from about 0.01 to about 2.99. In an example, X takes a value of about 1.0 for a stoichiometric CuMn₂O₄ spinel oxide powder. Still further to these embodiments, bulk powder of CuMn₂O₄ spinel is produced as described in U.S. patent application Ser. No. 13/891,617. In these embodiments, bulk powder Cu—Mn spinel is calcined at a plurality of temperatures within a range from about 600° C. to about 1000° C.

X-ray Diffraction Analysis for CuMn₂O₄ Spinel Phase Formation

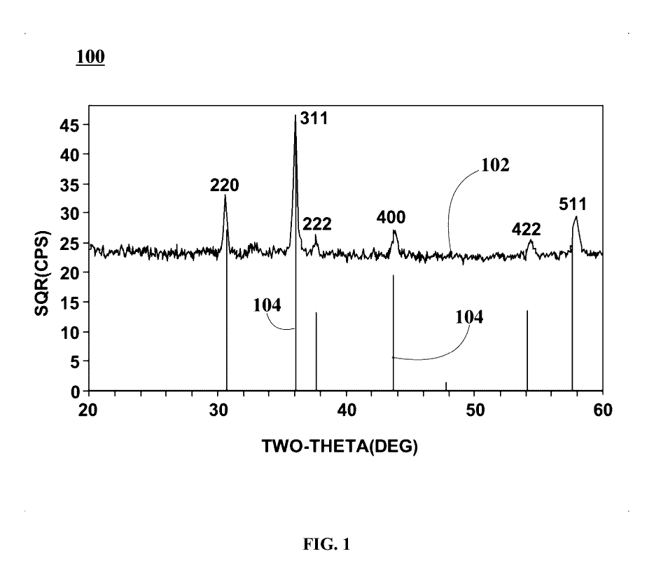

FIG. 1 is a graphical representation illustrating a powder X-ray diffraction (XRD) phase analysis of a copper (Cu)-manganese (Mn) spinel oxide, according to an embodiment. In FIG. 1, XRD analysis 100 includes XRD spectrum 102 and spectral lines 104.

In some embodiments, XRD spectrum 102 illustrates diffraction peaks of a fresh Cu—Mn spinel powder. In these embodiments and after calcination, pure CuMn₂O₄ spinel phase is produced, as illustrated by spectral lines 104. Further to these embodiments, pure CuMn₂O₄ spinel includes no contaminant and no secondary oxide phases. This result confirms the presence of pure and single phase CuMn₂O₄ spinel oxide within the produced spinel powder.

In FIG. 1, XRD analysis 100 indicates that the spinel structure of CuMn₂O₄ spinel exhibits a cubic symmetry (e.g., a=b=c and α=β=γ), where the lattice parameter “a” is about 8.3 Å. Additionally, the crystalline size of the CuMn₂O₄ spinel powder is about 33 nm.

Functional Testing and Characterization of CuMn₂O₄ Spinel Powder

In some embodiments, the behavior of the Cu—Mn spinel oxide powder is analyzed within oxidation-reduction environments to determine the reduction/oxidation (redox) reversibility, catalytic activity, and thermal stability of the Cu—Mn spinel oxide powder that result from the associated metal-oxygen-metal interactions during the oxidation-reduction cycling process. In these embodiments, functional testing and chemical characterization of Cu—Mn spinel powder are conducted to assess the formation of the spinel phase, the reversible redox property, thermal stability, and the catalytic activity of the Cu—Mn spinel powder. Further to these embodiments, the catalytic activity of the Cu—Mn spinel powder is determined employing a TWC light-off testing during a redox condition cycling process.

In some embodiments, the chemical characterization of the Cu—Mn spinel powder is performed during a redox condition cycling process. In these embodiments, the redox condition cycling process employs X-ray diffraction (XRD) analysis, hydrogen temperature-programmed reduction (H₂-TPR) technique, transmission electron microscopy (TEM) analysis, and X-ray photoelectron spectroscopy (XPS) analysis.

HRTEM-EDS Analysis of Fresh CuMn₂O₄ Spinel Powder

In some embodiments, the crystal structure of a fresh CuMn₂O₄ spinel powder is assessed by high-resolution transmission electron microscopy (HRTEM) in combination with an energy-dispersive X-ray spectroscopy (EDS) analysis. In these embodiments, the HRTEM-EDS analysis is employed to confirm the spinel oxide elemental composition.

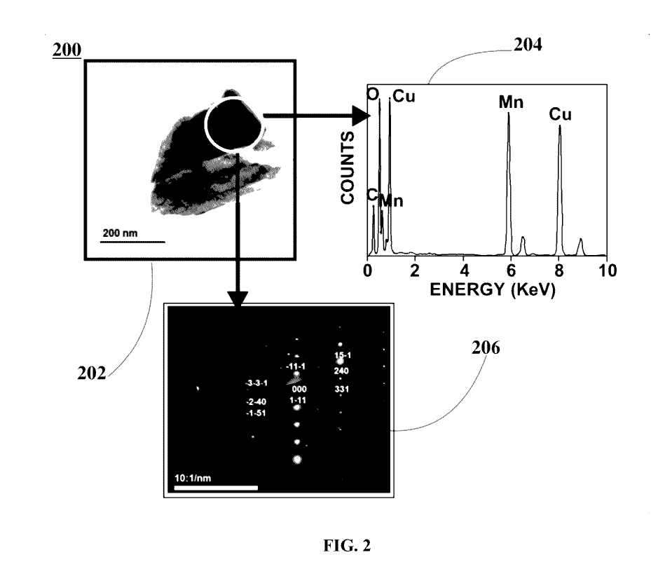

FIG. 2 is a graphical representation illustrating high-resolution transmission electron microscopy (HRTEM) and energy-dispersive X-ray spectroscopy (EDS) analyses of a fresh Cu—Mn spinel powder, according to an embodiment. In FIG. 2, HRTEM-EDS analysis 200 includes HRTEM micrograph 202, EDS spectrum 204, and selected area electron diffraction (SAED) pattern 206.

In some embodiments, the CuMn₂O₄ spinel spectra from the XRD data is verified by diffraction imaging and EDS measurements, which indicate minor variations in the Mn:Cu ratio. In these embodiments, all grains identified as CuMn₂O₄ spinel exhibit superlattice reflections. Further to these embodiments, detailed EDS measurements of different parts of a singular grain is illustrated by EDS spectrum 204. Still further to these embodiments, minor deviations in the Mn:Cu ratio are indicated by the EDS data. In these embodiments, electron diffraction pattern 206 verifies a CuMn₂O₄ spinel grain. Further to these embodiments, the small and weak, but very sharp spots arranged around the major reflections are seen as superlattice reflections. Still further to these embodiments, all grains identified as CuMn₂O₄ spinel exhibit aforementioned superlattice reflections in all orientations.

Reversibility of Cu—Mn Spinel Oxide Under Reduction/Oxidation Conditions

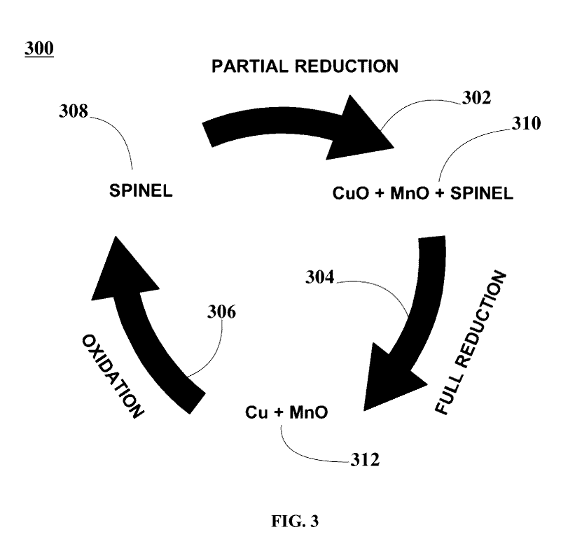

FIG. 3 is a graphical representation illustrating a reduction/oxidation (redox) reversibility cycle of a Cu—Mn spinel powder under reduction/oxidation conditions, according to an embodiment. In FIG. 3, reversibility cycle 300 includes partial reduction step 302, full reduction step 304, oxidation step 306, spinel phase 308, CuO/MnO/spinel phases 310, and Cu/MnO phases 312. In some embodiments, the complete redox cycle includes partial reduction step 302, full reduction step 304, and oxidation step 306.

In some embodiments, partial reduction step 302 is a partial reduction reaction of the Cu—Mn spinel oxide powder performed by means of a reducing gas. In these embodiments and after partial reduction step 302, Cu—Mn spinel oxide powder is characterized by means of an XRD analysis to detect the phases formed as a result of partial reduction step 302. Further to these embodiments, partial reduction step 302 is followed by a full reduction step 304 employing a substantially similar reducing gas as previously used in partial reduction step 302, above. Still further to these embodiments, Cu—Mn spinel oxide powder is then characterized by means of an XRD analysis to detect the phases formed as a result of full reduction step 304. In these embodiments, full reduction step 304 is followed by oxidation step 306 performed by employing an 02 gas composition to restore the Cu—Mn spinel oxide powder to an oxidized state. Further to these embodiments and after oxidation step 306, Cu—Mn spinel oxide powder is characterized by means of an XRD analysis to detect the phases formed and to confirm that the Cu—Mn spinel oxide exhibits a redox reversibility property.

In some embodiments, at the beginning of the redox reversibility cycle a pure CuMn₂O₄ spinel oxide phase within the bulk powder spinel is detected (spinel phase 308). In these embodiments, the redox reversible cycle continues during partial reduction step 302, in which partial reduction is performed employing a reducing gas having about 0.5% CO at about 600° C. for a duration of about 20 minutes. Further to these embodiments and after partial reduction step 302, mixed phases of CuO/MnO/spinel 310 are detected.

In some embodiments, the redox reversible cycle continues during full reduction step 304, in which full reduction is performed employing a reducing gas having about 0.5% CO at about 600° C. for a duration of about 120 minutes. In these embodiments, after full reduction step 304, mixed phases of Cu/MnO 312 are detected.

In some embodiments, the redox reversible cycle continues during oxidation step 306, in which oxidation is performed employing an oxidizing gas having about 0.5% 02 at about 600° C. for a duration of about 120 minutes. In these embodiments and after oxidation step 306, CuMn₂O₄ spinel oxide phase 308 is detected.

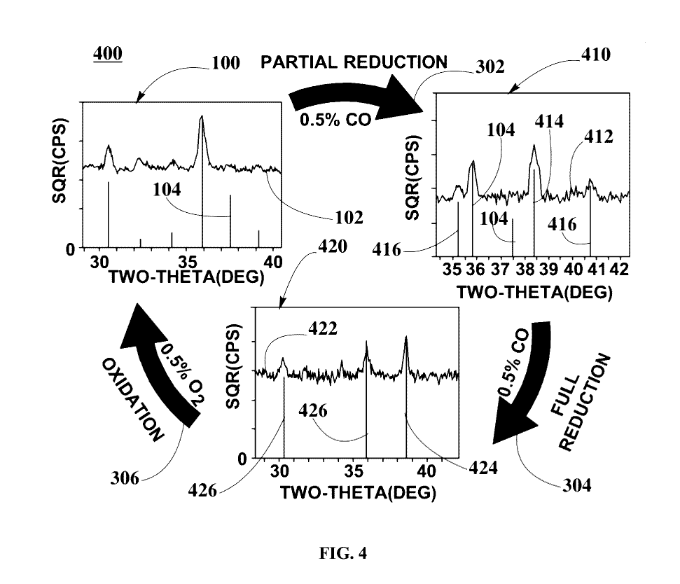

FIG. 4 is a graphical representation illustrating an XRD phase analysis for the entire redox reversibility cycle of a Cu—Mn spinel powder under reduction/oxidation conditions, according to an embodiment. In FIG. 4, XRD phase analysis 400 includes partial reduction step 302, full reduction step 304, oxidation step 306, XRD analysis 100, XRD analysis 410, and XRD analysis 420. XRD analysis 410 includes XRD spectrum 412 and spectral lines 104, 414, and 416. XRD analysis 420 includes XRD spectrum 422 and spectral lines 424 and 426. In FIG. 4, elements having substantially similar element numbers from previous figures function in a substantially similar manner.

In some embodiments and after partial reduction step 302, XRD spectrum 412 of XRD analysis 410 illustrates diffraction peaks for separate phases of CuO, MnO, and Cu—Mn spinel, as illustrated by spectral line 414, spectral lines 416, and spectral lines 104, respectively. In these embodiments and after full reduction step 304, XRD spectrum 422 of XRD analysis 420 illustrates diffraction peaks for separate phases of Cu and MnO, as illustrated by spectral lines 424 and 426, respectively. Further to these embodiments and after oxidation step 306, XRD spectrum 102 of XRD analysis 100 illustrates diffraction peaks of bulk powder Cu—Mn spinel. The results in FIGS. 3-4 confirm the reversibility of the Cu—Mn spinel oxide phase during a redox cycle.

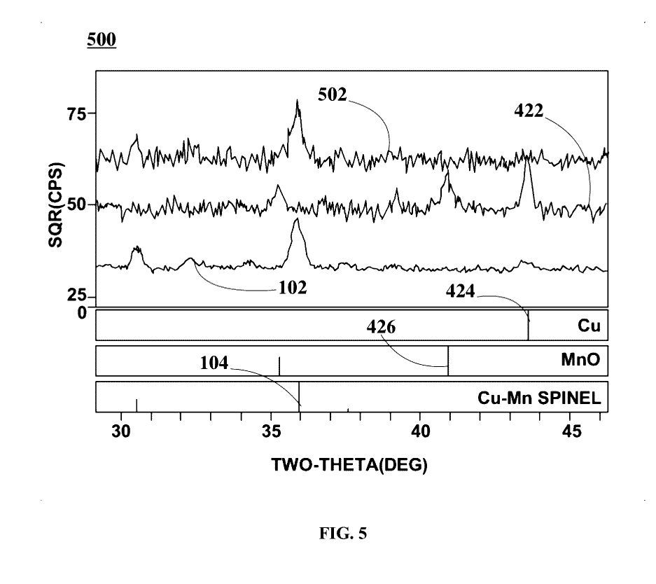

FIG. 5 is a graphical representation illustrating an XRD phase analysis of a Cu—Mn spinel powder fresh, after the reduction step, and after the oxidation step, according to an embodiment. In FIG. 5, XRD analysis 500 includes XRD spectrum 102, XRD spectrum 422, XRD spectrum 502, spectral line 424, spectral line 426, and spectral line 104. In FIG. 5, elements having substantially similar element numbers from previous figures function in a substantially similar manner.

In some embodiments, XRD analysis 500 indicates that after the oxidation step the Cu—Mn spinel is fully returned, as illustrated by XRD spectrum 502 and spectral line 104. In these embodiments, spectral line 104 represents the phase intensity of Cu—Mn spinel that is exhibiting an associated diffraction peak within XRD spectrum 502 that confirms the Cu—Mn spinel possesses a redox reversibility property during the oxidation-reduction process, as previously described in FIG. 3.

Temperature-Programmed Reduction (TPR) Test of Cu—Mn Spinel Powder

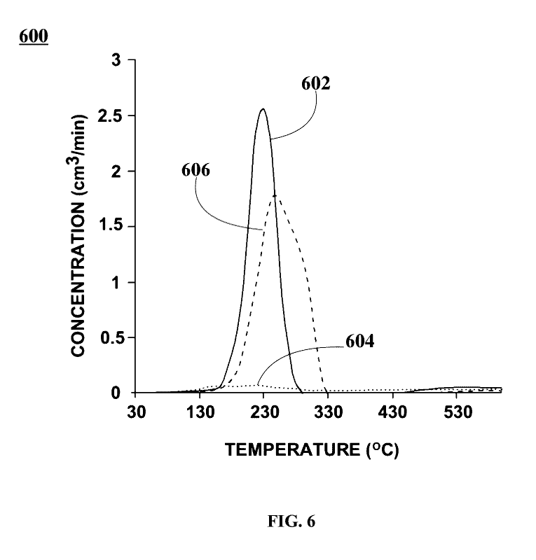

FIG. 6 is a graphical representation illustrating results from a hydrogen temperature-programmed reduction (H₂-TPR) test of a Cu—Mn spinel powder, according to an embodiment. In FIG. 6, H₂-TPR profile 600 includes TPR spectrum 602, TPR spectrum 604, and TPR spectrum 606, in which each spectrum represents associated hydrogen consumption at specific temperatures for Cu—Mn spinel powders at different reduction/oxidation stages.

In some embodiments, TPR spectrum 602, TPR spectrum 604, and TPR spectrum 606 illustrate the results of the H₂-TPR testing employed to characterize the reduction property of the Cu—Mn spinel oxide during the oxidation-reduction process. In these embodiments, the TPR test is performed employing a reducing gas mixture of about 10% H₂ diluted in argon (Ar), and the reversibility cycle (described in FIG. 3) conditions are performed using about 0.5% CO at about 600° C. for reduction condition, and under about 0.5% O₂ at about 600° C. for the oxidation condition. Further to these embodiments, the Cu—Mn spinel oxide powder samples at various stages of the redox reaction (e.g., fresh, after full reduction reaction, and after reduction-oxidation reaction cycle) is heated up at a temperature programmed ramp of 10° C./min up to a temperature of about 600° C., with a dwell time of about 3 minutes.

In some embodiments, TPR spectrum 602 illustrates the result of the H₂ consumption per gram of fresh Cu—Mn spinel as a function of temperature. In these embodiments, TPR spectrum 604 illustrates the result of the H₂ consumption per gram of a full reduced Cu—Mn spinel as a function of temperature. Further to these embodiments, TPR spectrum 606 illustrates the result of the H₂ consumption per gram of a re-oxidized Cu—Mn spinel as a function of temperature.

In some embodiments, the integration of the area under the associated curve provides the total hydrogen consumption (mL/g spinel) that occurs during the H₂-TPR test on a Cu—Mn spinel at various stages of the redox cycle. In these embodiments, H₂ consumption of TPR spectrum 602 is about 141.9 mL/g, TPR spectrum 604 is about 7.1 mL/g, and TPR spectrum 606 is about 149.1 mL/g. Further to these embodiments, the H₂ consumption of fresh spinel and spinel after redox reaction exhibit substantially similar H₂ consumption, thereby confirming that the Cu—Mn spinel phase is reversible.

Activity of Cu—Mn Spinel Powder

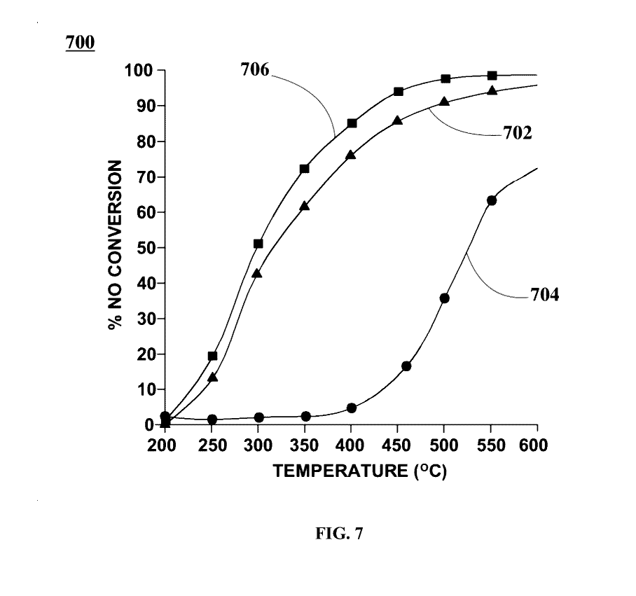

FIG. 7 is a graphical representation illustrating light-off (LO) test results of NO conversion percentages associated with a Cu—Mn spinel powder fresh, after the reduction step, and after an oxidation step, according to an embodiment. In FIG. 7, NO conversion comparison graph 700 includes NO conversion curve 702, NO conversion curve 704, and NO conversion curve 706.

In some embodiments, NO conversion curve 702, NO conversion curve 704, and NO conversion curve 706 illustrate the NO conversion percentage results before the reduction step (fresh), after the reduction step, and after the oxidation step, respectively.

In some embodiments, NO conversion curve 704 illustrates that NO conversion occurs at higher temperatures within a range from about 400° C. to about 600° C. under LO condition after the full reduction step. In these embodiments, the aforementioned NO conversion is attributed to Cu metal and MnO. Further to these embodiments, NO conversion curve 706 indicates that the re-oxidation of the Cu and MnO phases regenerates to Cu—Mn spinel, which exhibits slightly increased activity when compared with NO conversion curve 702 associated with the fresh Cu—Mn spinel. In summary, these results indicate that the Cu—Mn spinel structure exhibits stability towards oxidation-reduction during redox cycle.

Characterization of Cu—Mn Spinel Powder Employing XPS Analysis

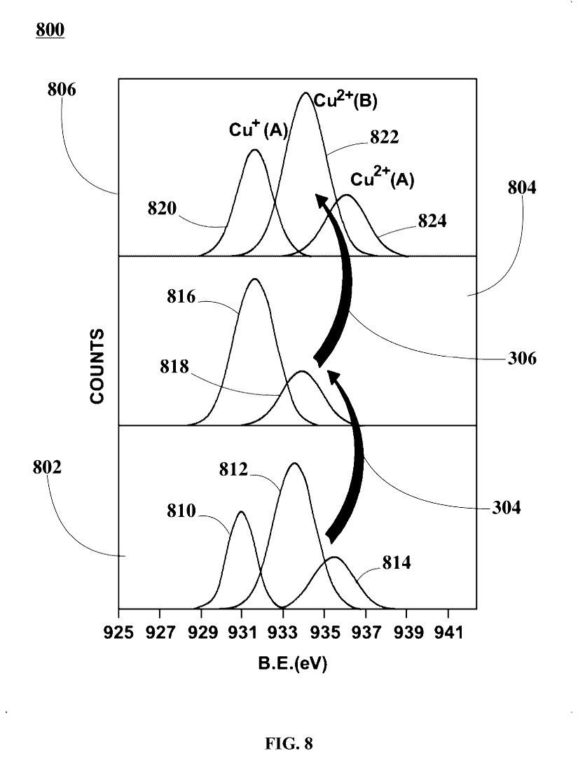

FIG. 8 is a graphical representation illustrating elemental oxidation states within the redox reversibility cycle of a Cu—Mn spinel powder employing X-ray photoelectron spectroscopy (XPS) analysis, according to an embodiment. In FIG. 8, XPS analysis 800 includes XPS spectrum 802, XPS spectrum 804, and XPS spectrum 806, full reduction step 304, and oxidation step 306. In some embodiments, XPS spectrum 802 includes Cu⁺ 810 within the A-site of the Cu—Mn spinel, Cu²⁺ 812 within the B-site of the Cu—Mn spinel, and Cu²⁺ 814 within the A-site of the Cu—Mn spinel. In these embodiments, XPS spectrum 804 includes Cu⁺ peak 816 and Cu²⁺ peak 818. Further to these embodiments, XPS spectrum 806 includes Cu⁺ peak 820, Cu²⁺ peak 822, and Cu²⁺ peak 824. In FIG. 8, elements having substantially similar element numbers from previous figures function in a substantially similar manner.

In some embodiments, XPS spectrum 802 illustrates the Cu2p_{3/2} de-convoluted peaks associated with a fresh Cu—Mn spinel before the reduction step of the reversibility cycle. In these embodiments, Cu⁺ peak 810 of XPS spectrum 802 possesses significantly less Cu⁺ cations than the total Cu cations possessed by Cu²⁺ peak 812 and Cu²⁺ peak 814 of XPS spectrum 802. Further to these embodiments, XPS spectrum 804 illustrates the Cu2p_{3/2} de-convoluted peaks associated with CuO/MnO/spinel phases during the reduction step of the reversibility cycle. In these embodiments, Cu⁺ peak 816 of XPS spectrum 804 possesses significantly more Cu⁺ cations than the Cu²⁺ cations possessed by Cu²⁺ peak 818 of XPS spectrum 804. Still further to these embodiments, XPS spectrum 806 illustrates the Cu2p_{3/2} de-convoluted peaks associated with a re-oxidized Cu—Mn spinel after the oxidation step of the reversibility cycle. In these embodiments, Cu⁺ peak 820 of XPS spectrum 806 possesses significantly less Cu cations than the total Cu²⁺ cations possessed by Cu²⁺ peak 822 and Cu²⁺ peak 824 of XPS spectrum 806.

In some embodiment and after full reduction step 304, Cu metal is not detected in XPS spectrum 804, and the intensity of Cu cations indicate that Cu²⁺ is significantly reduced. In these embodiments, CO²⁺ is reduced to Cu¹⁺. Further to these embodiments and after oxidation step 306, the intensity of Cu cations indicates that a re-oxidation of Cu¹⁺ to Cu²⁺ is detected in the reversibility cycle, as described in XPS spectrum 806.

In some embodiments and for the fresh Cu—Mn spinel powder, the Cu²⁺ concentration is higher than the Cu⁺ concentration, therefore majority of Cu cations within Cu—Mn spinel oxide is in form of Cu²⁺ . In these embodiments and after complete reduction cycle, the Cu⁺ concentration is higher than the Cu²⁺ concentration, thereby indicating that majority of the Cu cations are reduced to Cu⁺. Further to these embodiments and after re-oxidation (complete redox cycle) of the spinel oxide powder, the Cu—Mn spinel oxide powder exhibits again a higher concentration of Cu²⁺ than Cu⁺ concentration, thereby indicating the re-oxidation of Cu⁺ to Cu²⁺. Still further to these embodiments, the oxidation state of Cu within the Cu—Mn spinel oxide powder resulting from the XPS analysis confirms that the Cu—Mn spinel exhibit a reversible oxidation-reduction property.

TEM Analysis of Cu—Mn Spinel Powder after Reduction in a CO Environment

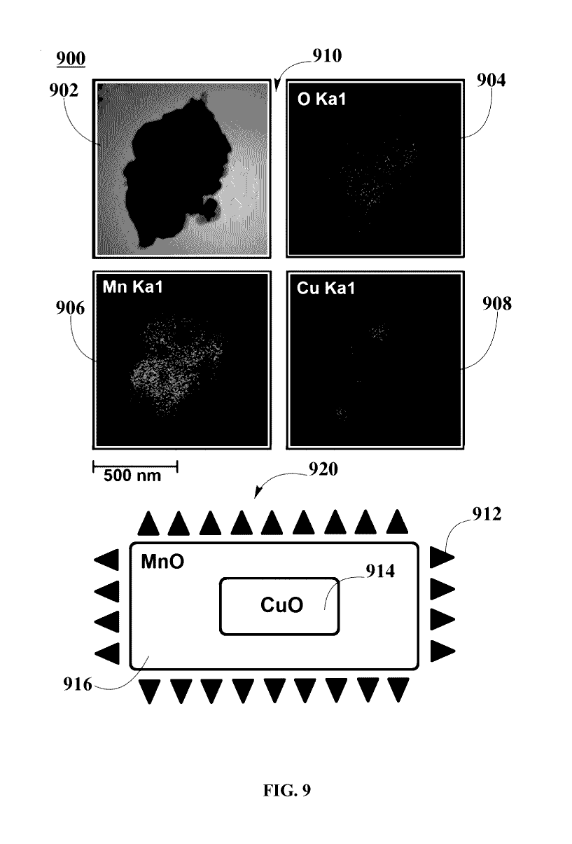

FIG. 9 is a graphical representation illustrating an elemental mapping analysis for a Cu—Mn spinel powder after partial reduction in a CO environment, employing scanning transmission electron microscopy (STEM) test and energy-dispersive X-ray spectroscopy (EDX) analysis, according to an embodiment. In FIG. 9, STEM-EDX graph 900 includes STEM-EDX map 910 and CuO/MnO/spinel phases diagram 920. STEM-EDX map 910 additionally includes STEM image 902, STEM image 904, STEM image 906, and STEM image 908. CuO/MnO/spinel phases diagram 920 further includes spinel phase 912, CuO phase 914, and MnO phase 916.

In some embodiments and referring to FIGS. 3 and 9, STEM image 902 illustrates a Cu—Mn spinel powder after partial reduction step 302 employing about 0.5% CO at about 600° C. for a duration of about 20 minutes. In these embodiments, STEM image 904 illustrates the mapping of oxygen (O₂) within Cu—Mn spinel powder after partial reduction step 302. Further to these embodiments, STEM image 906 illustrates mapping of elemental Mn after partial reduction step 302. Still further to these embodiments, STEM image 908 illustrates mapping of elemental Cu after partial reduction step 302.

In some embodiments, spinel phase 912 illustrates the distribution of CuO/MnO/ spinel phases associated with a Cu—Mn spinel powder after partial reduction step 302. In these embodiments, CuO phase 914 illustrates Cu-rich phases associated with a Cu—Mn spinel powder after partial reduction step 302. Further to these embodiments, MnO phase 916 illustrates Mn-rich phases associated with a Cu—Mn spinel powder after partial reduction step 302.

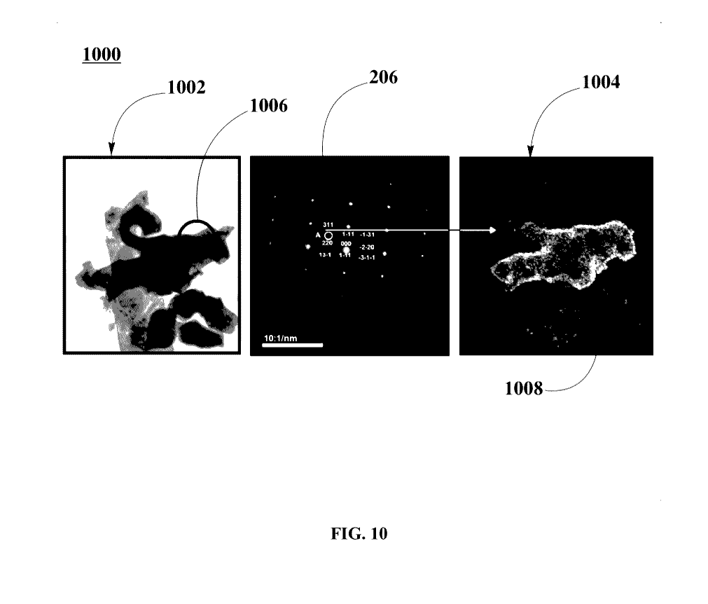

In some embodiments, as illustrated by STEM images 906 and 908, the Cu-map exhibits significantly defined and separate Cu-rich phases (CuO phase 914) surrounded by Mn-rich phases (MnO phase 916). In these embodiments, these results confirm the phase separation of Cu and Mn surrounded by spinel phase 912 particles in a partial reduced sample. Further to these embodiments and referring to XRD data, the Mn- and Cu-phases are found to be MnO and CuO. Still further to these embodiments, the STEM-EDS mapping exhibits a phase separation of Cu and Mn surrounded by spinel phase 912 particles. The presence of spinel crystals around the CuO/MnO is confirmed in FIG. 10, below.

FIG. 10 is a graphical representation illustrating a transmission electron microscopy (TEM) analysis of a Cu—Mn spinel powder after partial reduction in a CO environment, according to an embodiment. In FIG. 10, TEM analysis 1000 includes micrograph 1002, electron diffraction pattern 206, and dark field image 1004. Micrograph 1002 additionally includes selected area 1006. Dark field image 1004 further includes CuMn₂O₄ grains 1008. In FIG. 10, elements having substantially similar element numbers from previous figures function in a substantially similar manner.

In some embodiments, many nano-sized crystals of a second phase cover the surface of the MnO crystals as illustrated by the particular diffraction patterns that related to CuMn spinet. In these embodiment and referring to electron diffraction pattern 206, the Mn-rich phase has the MnO crystal structure. Further to these embodiments, a pattern of weak reflections in the background reveals a second phase as it is described in CuO/MnO/spinel phases diagram 920. In these embodiments, dark field image 1004 confirms the existence of nano-sized crystals on the surface of MnO grains.

In summary, XRD, XPS, TPR, and activity measurements confirm the significant redox reversibility property of the Cu—Mn spinel oxide during the complete redox cycle. In other words, the Cu—Mn spinel oxide, which is free of PGM and rare-earth metals, exhibits significant redox stability and reversibility that can enable catalyst materials in bulk powder format for the development of a plurality of TWC systems and other catalyst applications.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A catalytic composition of a binary Cu—Mn spinel in which the catalytic composition comprises
a) a binary Cu—Mn spinel of the formula Cu_{X}Mn_{3-X}O₄, wherein X is a number from 0.01 to 2.99, and wherein the spinel comprises mixed phases of CuO, MnO and Cu_{X}Mn_{3-X}O₄; b) a mixture of Cu and MnO; c) or a combination of a) and b).

2. The catalytic composition of claim 1, wherein the Cu—Mn spinel is CuMn₂O₄.

3. The catalytic composition of claim 1, wherein the composition is in the form of a powder.

4. The catalytic composition according to claim 1, wherein the Cu—Mn spinel is in a partially reduced state.

5. The catalytic composition according to claim 1, wherein the Cu—Mn spinel is in a fully reduced state.

6. The catalytic composition according to claim 1, wherein the composition comprises a CuO phase surrounded by a MnO phase.

7. The catalytic composition of claim 6, wherein the MnO phase is surrounded by Cu—Mn spinel particles.

8. The catalytic composition of claim 1, wherein the composition is free of platinum group metals.

9. The catalytic composition of claim 1, wherein a concentration of Cu²⁺ is higher than a concentration of Cu¹⁺ in the catalytic composition.

10. A catalytic converter comprising the composition of claim 1.

11. A method of removing one or more of nitrous oxide (NOx), carbon monoxide (CO) and hydrocarbons (HC) from an exhaust stream comprising the step of contacting the exhaust stream comprising one or more of NOx, CO, or HC with a catalytic composition, the catalytic composition comprising a) a binary Cu—Mn spinel of the formula Cu_{X}Mn_{3-X}O₄, wherein X is a number from 0.01 to 2.99, and wherein the spinel comprises mixed phases of CuO, MnO and Cu_{X}Mn_{3-X}O₄; b) a mixture of Cu and MnO; c) or a combination of a) and b).

12. The method of claim 11, wherein the catalytic composition comprises said mixed phases of CuO, MnO and Cu_{X}Mn_{3-X}O₄.

13. The method of claim 11, wherein the catalytic composition comprises a mixture of Cu and MnO, and wherein the step of contacting the exhaust stream is carried out at a temperature of 400° C. to 600° C.

14. The method of claim 11, wherein the Cu—Mn spinel is CuMn₂O₄.

15. The method of claim 11, further comprising the step of oxidizing the catalyst composition to form a binary Cu—Mn spinel of the formula Cu_{X}Mn_{3-X}O₄, wherein X is a number from 0.01 to 2.99.

16. A method of removing pollutants from a gas stream comprising:
a) contacting an exhaust stream comprising one or more of NOx, CO, or HC with a catalytic composition comprising a binary Cu—Mn spinel of the formula Cu_{X}Mn_{3-X}O₄, wherein X is a number from 0.01 to 2.99, and wherein the step of contacting results in a reduction of one or more of NOx, CO, or HC in the exhaust stream, and in the Cu—Mn spinel being reduced or partially reduced;
b) contacting the exhaust stream with the reduced or partially reduced Cu—Mn spinel at a temperature that is between about 400° C. to about 600° C.; and
c) oxidizing the catalytic composition following step b) to form a binary Cu—Mn spinel of the formula Cu_{X}Mn_{3-X}O₄.

17. The method of claim 16, wherein the partially reduced Cu—Mn spinel comprises mixed phases of CuO, MnO and Cu_{X}Mn_{3-X}O₄.

18. The method of claim 16, wherein the reduced Cu—Mn spinel comprises a mixture of Cu and MnO.

19. The method of claim 16, wherein the Cu—Mn spinel is in a partially reduced state, and wherein the composition comprises a CuO phase surrounded by a MnO phase on which Cu—Mn spinel particles are deposited.

20. The method of claim 16, wherein following step c), the concentration of Cu²⁺ is higher than the concentration of Cu¹⁺ in the catalytic composition.
